(19) United States
(12) Patent Application Publication
(10) Pub. No.: US 2003/0010778 A1
(43) Pub. Date: Jan. 16, 2003

(54) Microwave-safe food container

(75) Inventor: Sun Chang Kim, Seoul (KR)

Correspondence Address: HARRISON & EGBERT, 412 MAIN STREET, 7TH FLOOR, HOUSTON, TX, 77002, US

(73) Assignee: Nam Kyoung Chemical Co., Ltd.

(21) Appl. No.: 09/844,513

(22) Filed: Apr. 30, 2001

(30) Foreign Application Priority Data
Mar. 28, 2001 (KR) 2001-8563

(51) Int. Cl. H05B 6/80

(52) U.S. Cl. 219/734

(57) ABSTRACT

A microwave-safe food container is disclosed. In the food container of this invention, the container body is thermally sealed along its junction, with a heat seal modifier applied to a predetermined portion of the junction prior to performing a thermal sealing process of sealing the body along the junction. The container body is fabricated of a material selected from a nylon film, a polyester film, a polypropylene film, a polyethylene film, or paper impregnated with synthetic resin. This food container effectively prevents an excessive evaporation of moisture from food, and so the container maintains an appropriate moisture content of some moist food after a heating or cooking process, thus maintaining desired taste of such moist food.

### BACKGROUND OF THE INVENTION

1. Field of the Invention

The present invention relates to a microwave-safe food container suitable for packing food to be displayed and sold in a prepackaged state, and heated in microwave ovens prior to being served.

2. Description of the Prior Art

In accordance with the social modernization, such as the trend of division of an extended family into nuclear families, the dietary lifestyle of people has been changed to frequently take snacks in place of taking cooked food. In addition, microwave ovens that are the time-saving cookers have been preferably and widely used since they are convenient to users, in addition to simplifying the cooking processes.

A microwave oven is design to contain food in its heating chamber made of a metal, and heat the food using microwaves, or high-frequency electromagnetic waves. Therefore, the food heating style of the microwave ovens is different from the conventional conduction heating style or the conventional induction heating style.

That is, during an operation of a microwave oven, microwaves are radiated from a microwave antenna into the heating chamber at the speed of light, and excite the covalent bonds in water molecules of food, thus causing them to vibrate faster while creating intramolecular frictional heat in the food. The intramolecular frictional heat of the food is converted into thermal energy, which heats the food.

The microwave ovens are advantageous in that they are preferably usable for a variety of applications, such as food cooking or food defrosting, and are easily and simply operated by a user without deforming the shape of food during a food heating or cooking process. The microwave ovens also quickly heat or cook food in a desired short time, in addition to sterilizing the food. However, the microwave ovens are problematic in that they cannot maintain the taste of some moist food, such as frozen stuffed buns, frozen pizza, steamed bread, or steamed rice, since the microwave ovens excessively evaporate moisture of such food even though such moist food has to maintain an appropriate moisture content after a heating or cooking process so as to maintain its desired taste.

The heating technique used in the microwave ovens excessively evaporates the moisture from food, different from conventional conduction or induction heating technique, since the microwave ovens are designed to directly heat exposed food using the microwaves within a large heating chamber.

Frozen stuffed buns or frozen pizza is displayed and sold in the state of being packed and sealed with a container made of synthetic resin. However, the synthetic resin container of the frozen stuffed buns or frozen pizza must be opened before the buns or pizza is heated or cooked within a microwave oven. When the frozen stuffed buns or the frozen pizza is heated or cooked within a microwave oven without opening the container so as to prevent an evaporation of moisture from the food, air within the sealed container is expanded to make the container burst. When the synthetic resin container bursts due to thermal expansion of air during a heating or cooking process, a plurality of pieces of the bursting container stick to the walls of the heating chamber of the oven so as to be melted and fixed on the walls. In such a case, the oven may be not usable. When the frozen stuffed buns or the frozen pizza is heated or cooked within a microwave oven while being covered with a metal bowl so as to prevent both an evaporation of moisture and a bursting of the synthetic resin container, the metal bowl undesirably intercepts microwaves. In such a case, it is impossible to heat or cook the food.

In an effort to overcome the above-mentioned problems, Korean Utility Model Registration No. 192,376 discloses a microwave-safe food container, which is provided with a plurality of micro holes at a predetermined portion thereof for preventing an excessive evaporation of moisture from food during a microwave heating or cooking process. The micro holes of the above-mentioned food container each have a diameter of 0.2 mm˜0.5 mm, and are normally sealed with a hot melt adhesive tape, but are melted to open the micro holes when heated within a microwave oven to allow air to be discharged from the container to the heating chamber during a heating process. However, the microwave-safe food container is problematic in that it is difficult to produce the container. That is, it is necessary to form a plurality of micro holes on a predetermined portion of the container, and precisely attach a hot melt adhesive tape to the container to seal the holes, thus complicating the process of producing the container. In addition, it is also necessary to prepare the hot melt adhesive tape, in addition to the container having the micro holes. This increases the production cost of such containers. The above food containers with the hot melt adhesive tapes are typically sold in the rolled state. However, when the food containers with the hot melt adhesive tapes are rolled to form a container roll, the container roll partially juts out at a portion around the tapes. This undesirably limits the number of containers in each container roll.

### SUMMARY OF THE INVENTION

Accordingly, the present invention has been made keeping in mind the above problems occurring in the prior art, and an object of the present invention is to provide a microwave-safe food container, which is thermally and totally sealed along the junction after applying a heat seal modifier to a predetermined portion of the junction, and which is preferably used for packing some moist food to be displayed and sold in a prepackaged state, and heated in microwave ovens prior to being served.

In order to accomplish the above object, the present invention provides a microwave-safe food container, comprising a body thermally sealed along its junction with a heat seal modifier applied to a predetermined portion of the junction prior to performing a thermal sealing process of sealing the body along the junction.

In the microwave-safe food container, the body is made of a nylon film, a polyester film, a polypropylene film, a polyethylene film, or paper impregnated with synthetic resin.

### BRIEF DESCRIPTION OF THE DRAWINGS

The above and other objects, features and other advantages of the present invention will be more clearly understood from the following detailed description taken in conjunction with the accompanying drawings, in which:

FIG. 1a is a perspective view of a microwave-safe food container in accordance with the preferred embodiment of the present invention;

FIG. 1b is a sectional view of the microwave-safe food container taken along the line A-A′ of FIG. 1a;

FIG. 1c is a sectional view of the microwave-safe food container taken along the line A-A′ of FIG. 1a, when air is discharged from the container to the cooking chamber of a microwave oven through a heat seal modifier-applied portion of the junction of a cover and a container body;

FIG. 1d is a sectional view of the microwave-safe food container taken along the line B-B′ of FIG. 1a;

FIG. 1e is a sectional view of the microwave-safe food container taken along the line B-B′ of FIG. 1a, when air is discharged from the container to the cooking chamber of the microwave oven through the heat seal modifier; and

FIG. 2 is a perspective view of a microwave-safe food container in accordance with the second embodiment of the present invention.

### DETAILED DESCRIPTION OF THE INVENTION

Reference now should be made to the drawings, in which the same reference numerals are used throughout the different drawings to designate the same or similar components.

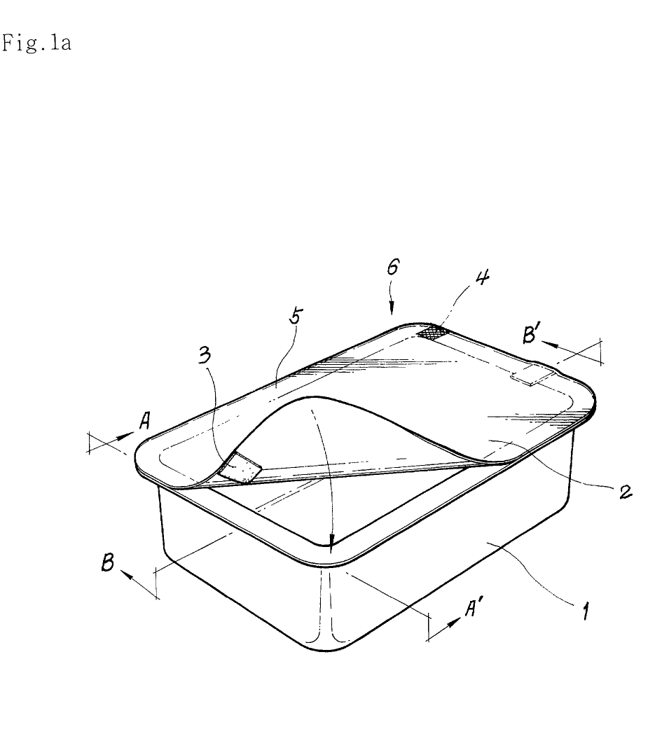

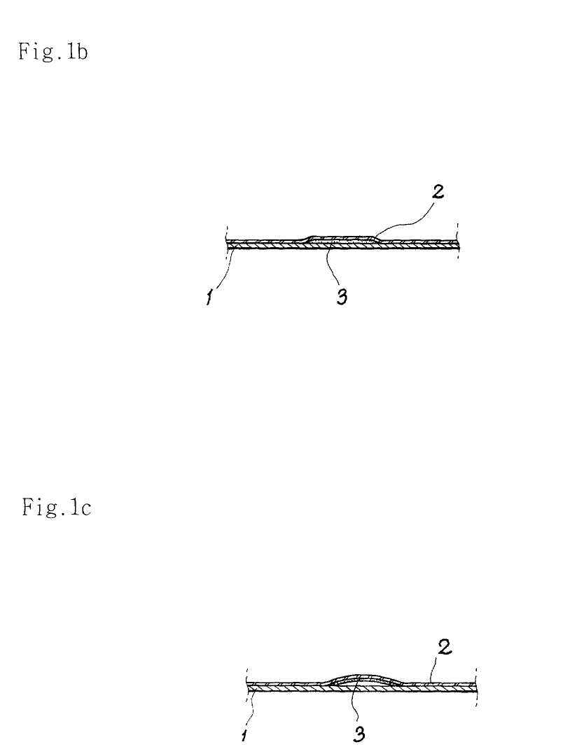

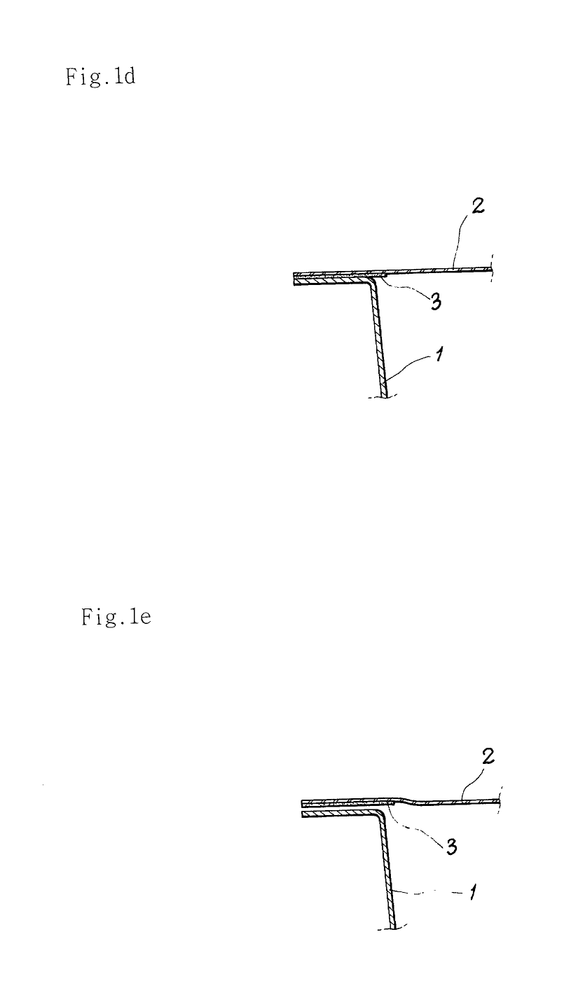

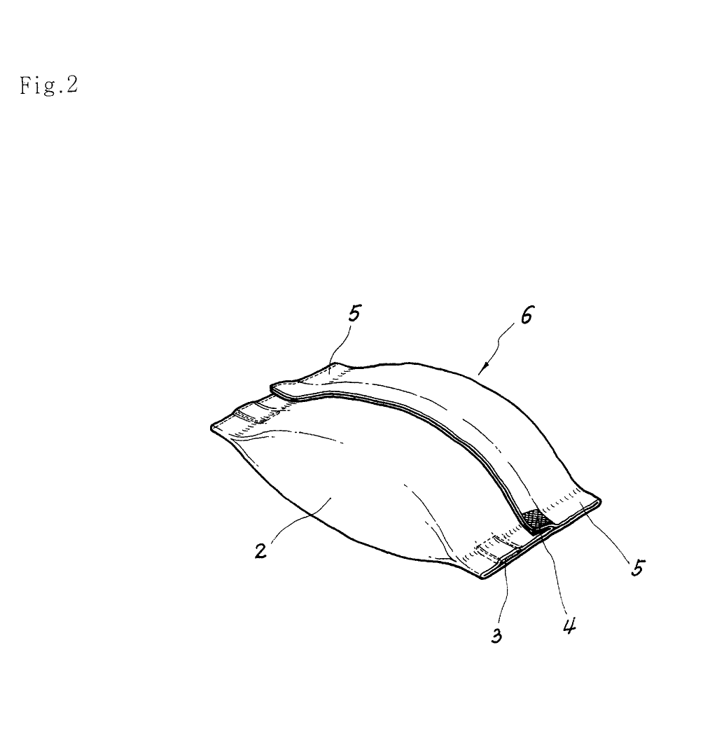

FIGS. 1a to 1e are views of a microwave-safe food container in accordance with the preferred embodiment of the present invention. FIG. 2 is a perspective view of a microwave-safe soft container in accordance with the second embodiment of the present invention. As shown in the drawings, the microwave-safe food container of this invention is thermally and totally sealed along the junction 5 after applying a heat seal modifier 3 to a predetermined portion of the junction 5.

In the present invention, the heat seal modifier 3 is a kind of hot melt adhesive agent that controls the sealing strength of the junction 5 when thermally sealing the junction 5. That is, the portion of the junction 5, having the heat seal modifier 3, is lower in its sealing strength than the other parts, and so the portion is opened prior to the other parts of the junction 5 when the container is heated at a low temperature.

The heat seal modifier 3 is produced by mixing a cellulose-based adhesive agent with a urethane resin-based hot melt adhesive agent. In such a case, the cellulose-based adhesive agent is easily dissolved with the urethane resin-based hot melt adhesive agent, and is lower in its adhesive force than the hot melt adhesive agent.

The food container of this invention having the heat seal modifier 3 reliably maintains its sealed state when it is transported, displayed or sold, but is softened at the portion having the heat seal modifier 3 prior to the other parts of the junction 5 when the container is heated in a microwave oven. When the container is further heated, the heated moist air is expanded and discharged from the container to the heating chamber of the oven through the softened portion of the junction 5 having the heat seal modifier 3. Therefore, the microwave-safe food container of this invention does not burst, in addition to desirably limiting the quantity of moist air discharged from the container during a heating or cooking process. Moist food within the container thus maintains an appropriate moisture content after a heating or cooking process, and maintains its desired taste. Of course, it should be understood that the moisture content of moist food after a heating or cooking process can be controlled by changing the kind of the heat seal modifier 3 and/or changing the size of the heat seal modifier-applied portion.

In the present invention, the microwave-safe food container is preferably fabricated of a material selected from a polyethylene film, a polypropylene film, a stretchable polyester film, a stretchable polypropylene film, a nylon film, and paper impregnated with synthetic resin.

A better understanding of the present invention may be obtained through the following examples which are set forth to illustrate, but are not to be construed as the limit of the present invention.

### EXAMPLE 1

300 g of stuffed buns, prepackaged in the microwave-safe food container 6 having a box shape according to the primary embodiment of FIG. 1a and frozen at a temperature of −15° C., were heated in a microwave oven. The volumetric capacity of the container 6 was about 400 cc. The food container 6 was made of a polypropylene film, while a heat seal modifier 3, produced by mixing a cellulose-based adhesive agent with a urethane resin-based hot melt adhesive agent, was applied to a predetermined portion of the junction 5 of a container body 1 and a cover film 2.

The food container 6 comprised the container body 1 and the cover film 2. The container body 1 had a box shape, while a top flange was formed along the top edge of the body 1. The cover film 2 was thermally sealed along the top flange of the body 1, thus forming a junction 5.

In order to seal the container 6 of this embodiment, the heat seal modifier 3 was applied to a predetermined portion of the junction 5 prior to performing a thermal sealing process as shown in FIG. 1a. The thermal sealing process was performed along the entire junction 5.

The hot melt adhesive agent included in the heat seal modifier 3 had a softening point of 160° C.

In FIG. 1a, the reference numeral 4 denotes an eye mark, which allows an automatic packaging machine to automatically sense the position of the cover film 2 during an automatic packaging process.

When the frozen stuffed buns were heated in the microwave oven for about 150 seconds, the buns were highly appetizing. When 120 seconds had elapsed after the oven was operated, expanded air was initially discharged from the container 6 through the softened portion of the junction 5 having the heat seal modifier 3. The stuffed buns maintained an appropriate moisture content after the heating process, and maintained their desired taste.

### EXAMPLE 2

100 g of steamed bread, prepackaged in the microwave-safe food container 6 according to the second embodiment of FIG. 2, was heated in a microwave oven. The volumetric capacity of the container 6 was about 200 cc.

The food container 6 was made of a polyester film, while a heat seal modifier 3 was applied to a predetermined portion of the sealed junction 5 of the container 6 prior to performing a thermal sealing process of sealing the container 6 along the junction 5. The hot melt adhesive agent, included in the heat seal modifier 3, had a softening point of 35° C. In FIG. 2, the reference numeral 4 denotes an eye mark, which allows an automatic packaging machine to automatically sense the position of the cover film 2 during an automatic packaging process.

When the steamed bread was heated in the microwave oven for about 40˜50 seconds, the bread was highly appetizing. When 40 seconds had elapsed after the oven was operated, expanded air was initially discharged from the container 6 through the softened portion of the junction 5 having the heat seal modifier 3. The bread maintained an appropriate moisture content after the heating process, and maintained its desired taste.

As described above, the present invention provides a microwave-safe food container. This container is thermally and totally sealed along the junction after applying a heat seal modifier to a predetermined portion of the junction. The food container of this invention effectively prevents an excessive evaporation of moisture from food, and so the container maintains an appropriate moisture content of some moist food after a heating or cooking process, thus maintaining desired taste of such moist food.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A microwave-safe food container, comprising a body thermally sealed along its junction with a heat seal modifier applied to a predetermined portion of said junction prior to performing a thermal sealing process of sealing the body along the junction.

2 The microwave-safe food container according to claim 1, wherein said body is fabricated of a material selected from a nylon film, a polyester film, a polypropylene film, a polyethylene film, and paper impregnated with synthetic resin.
